(19) United States
(12) Patent Application Publication
(10) Pub. No.: US 2011/0249870 A1
(43) Pub. Date: Oct. 13, 2011

(54) METHOD OF OCCLUSION HANDLING

(75) Inventors: Chao-Chung CHENG, Taipei (TW); YUNG-LIN HUANG, Taipei (TW); Yen-Chieh LAI, Taipei (TW); WEI-TING SUEN, Tainan (TW); YING-RU CHEN, Tainan (TW)

(73) Assignees: NATIONAL TAIWAN UNIVERSITY, Taipei (TW); HIMAX TECHNOLOGIES LIMITED, TAINAN (TW); HIMAX MEDIA SOLUTIONS, INC., TAINAN (TW)

(21) Appl. No.: 12/756,859

(22) Filed: Apr. 8, 2010

(51) Int. Cl. G06K 9/36; G06K 9/00

(52) U.S. Cl. 382/107; 382/284

(57) ABSTRACT

In a method of occlusion handling, a reference frame and a current frame are first provided, and at least one foreground object is determined. At least a covered region or an uncovered region with respect to the foreground object is determined. The covered region is then interpolated exclusively accordingly to the current frame, or the uncovered region is interpolated exclusively according to the reference frame.

### BACKGROUND OF THE INVENTION

1. Field of the Invention

The present invention generally relates to motion compensation, and more particularly to a method of occlusion handling adaptable to frame rate up conversion (FRUC).

2. Description of Related Art

Frame rate up conversion (FRUC) is commonly used in a digital image display such as digital TV to generate one or more intermediate frames between two original adjacent frames, such that the display frame rate may be increased, for example, from 60 Hz to 120 Hz or 240 Hz. The generation of the intermediate frame is typically performed by using an interpolation of motion compensation technique.

However, some area in the video frame may turn out not to exist in the previous frame or the current frame. The interpolation based on nonexistent pixels or blocks may thus result in error. Shown in FIG. 1 is an example in which an object 10 is located on the left-hand side in the previous frame, and the object 10 moves rightward to the right-hand side in the current frame. It is observed that, as the left-hand side area is covered or occluded by the object 10, the left-hand side area 12 in the current frame therefore does not have corresponding pixels or blocks in the previous frame. The occlusion exemplified in FIG. 1 will result in erroneous interpolation in the motion compensation.

For the reason that conventional motion compensation usually suffers from distortion due to occlusion effect, a need has arisen to propose a novel scheme in order to effectively and correctly handle the occlusion effect.

### SUMMARY OF THE INVENTION

In view of the foregoing, it is an object of the embodiment of the present invention to provide a method of occlusion handling that may determine and then correct occlusion regions in order to correctly perform motion compensation.

According to one embodiment of the present invention, a reference frame and a current frame are first provided, and at least one foreground object is determined. At least a covered region or an uncovered region with respect to the foreground object is determined. The covered region is then interpolated exclusively accordingly to the current frame, or the uncovered region is interpolated exclusively according to the reference frame. The embodiment may further include a step of correcting the motion vector of the covered or the uncovered region. Specifically, at least one macroblock (MB) of the current frame is inversely mapped to the interpolated frame. At least two inverse-mapped MBs in the interpolated frame closest to the interpolated MB are selected as candidates. Among the candidates, the MB that has a motion vector (MV) substantially consistent with the MVs of the MBs adjacent to the interpolated MB is selected as the MV of interpolated MB.

### BRIEF DESCRIPTION OF THE DRAWINGS

FIG. 1 shows conventional exemplary occlusion;

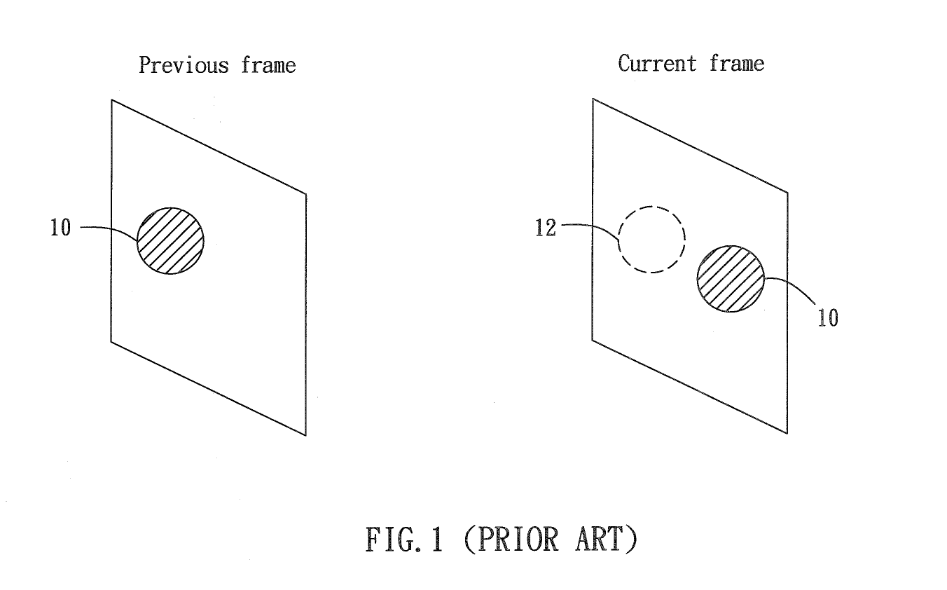

FIG. 2 shows a flow diagram that illustrates a method of occlusion handling according to one embodiment of the present invention;

FIG. 3A shows an example depicting a covered region and an uncovered region; and

FIG. 3B shows another example depicting a covered region and an uncovered region.

### DETAILED DESCRIPTION OF THE INVENTION

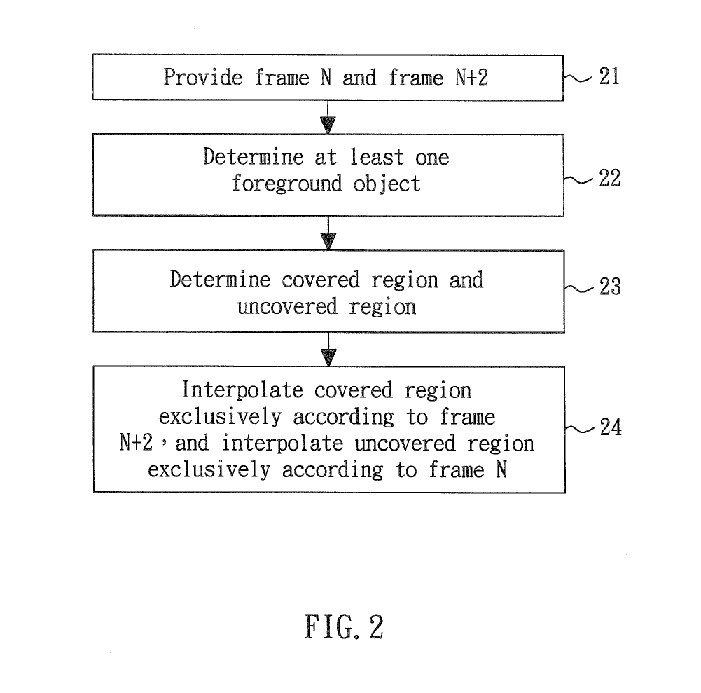

FIG. 2 shows a flow diagram that illustrates a method of occlusion handling adaptable, for example, to frame rate up conversion (FRUC) according to one embodiment of the present invention.

In step 21, a previous frame (which is usually called a reference frame) and a current frame are first provided, such that a new frame may be generated between the previous frame and the current frame by use of an interpolation technique. Generally speaking, a frame at time N and a frame at time N+2 are provided, such that an interpolated frame may be generated at time N+1 by motion estimation and motion compensation. The motion estimation and motion compensation may be either pixel-based or block-based. Regarding the block-based motion estimation and motion compensation, each frame is divided into non-overlapping rectangular regions called macroblocks (MBs). Each of the MBs may have a size of, for example, 4×4 or 16×16. The block-based motion estimation is disclosed in a co-pending U.S. patent application No. 12/756,459, filed Apr. 8, 2010, Cheng et al., entitled “Method of block-based motion estimation,” assigned to the same assignee, the disclosure of which is hereby incorporated by reference.

Subsequently, in step 22, at least one foreground object is determined or detected. As the foreground object commonly moves faster than the background, that is, the motion vector (MV) of the foreground is commonly greater than the MV of the background, the foreground object is accordingly determined in the embodiment as the object that has a greater motion vector.

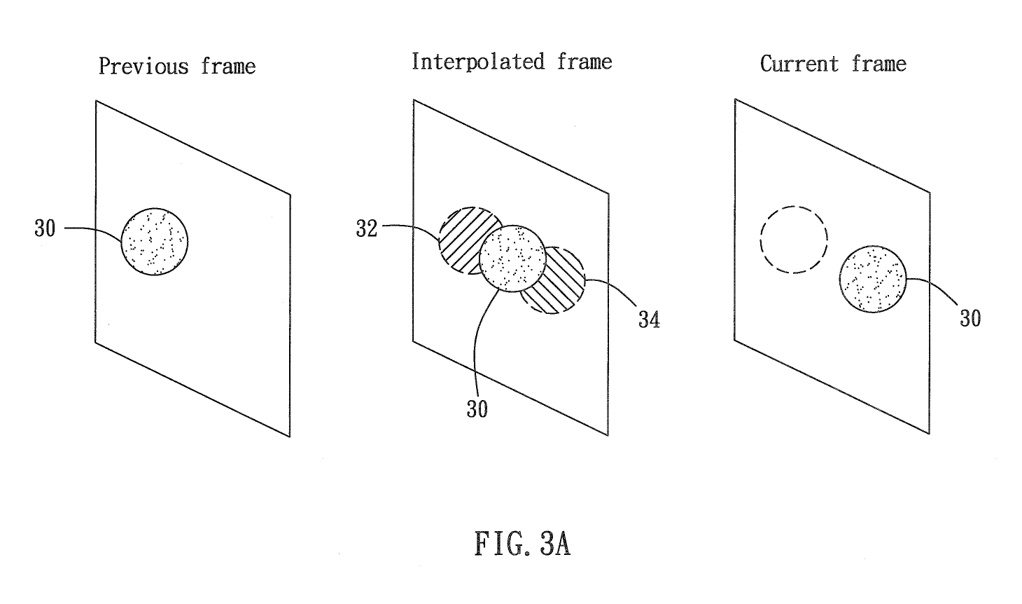

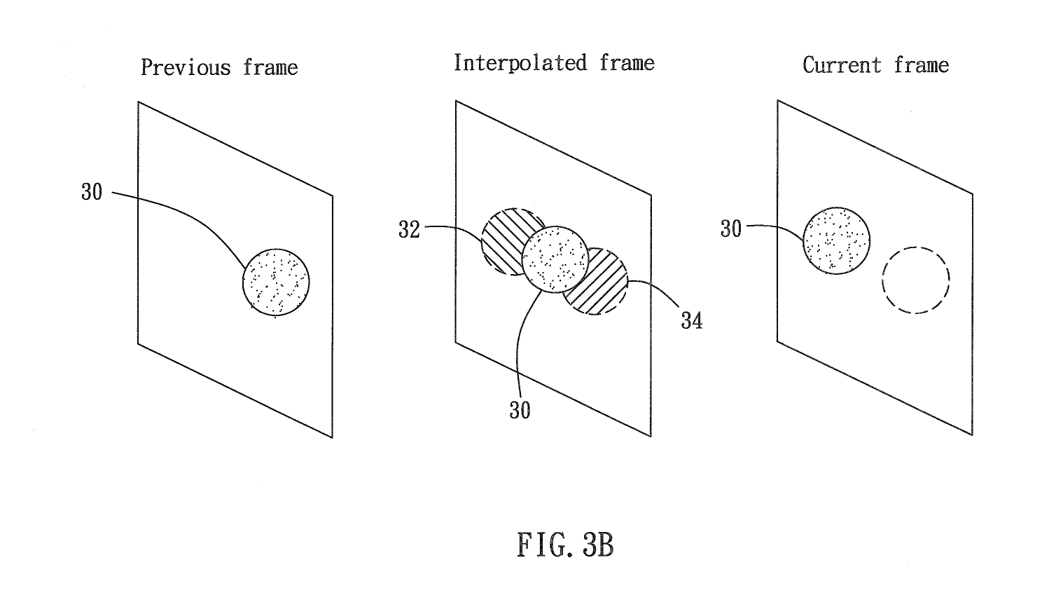

Exemplified in FIG. 3A is a previous frame, a current frame and an interpolated frame. In the figure, a moving foreground object 30 moves rightward with respect to the background. It is observed, in the interpolated frame, that there are a region 32 on the left-hand side of the foreground object 30 and a region 34 on the right-hand side of the foreground object 30. The region 32 is covered by the foreground object 30 in the previous frame, and the region 32 is thus called a “covered” region in the specification. On the other hand, as the region 34 is not covered by the foreground object 30 in the previous frame but is covered by the foreground object 30 in the current frame, the region 34 is called an “uncovered” region in the specification. If the foreground object 30 moves leftward instead, as shown in FIG. 3B, the left-hand side region 32 thus becomes the “uncovered” region with the right-hand side region 34 becoming the “covered” region.

In step 23, at least a covered region and an uncovered region adjacent to a foreground object are determined. In the embodiment, a region located toward a direction opposite to the moving direction of the foreground object is determined as the covered region. On the other hand, a region located toward a direction the same as the moving direction of the foreground object is determined as the uncovered region.

Afterwards, in step 24, the covered region (e.g., the region 32 in FIG. 3A) in the interpolated frame is interpolated exclusively according to the current frame or the frame at time N+2. The uncovered region (e.g., the region 34 in FIG. 3A) in the interpolated frame is interpolated exclusively according to the previous frame or the frame at time N. The interpolation of the covered/uncovered region may be performed using, among other things, a forward or backward motion vector map, or may be performed simply by duplicating the corresponding background region if the background is approximately unmoving (e.g., standing still).

It is noted that the motion vector (MV) of the covered/uncovered region may be error-prone due to the moving foreground object. In order to resolve this problem, the erroneous MV of the covered/uncovered region may be corrected before the covered/uncovered region is to be or being interpolated. With respect to the block-based motion estimation method disclosed in the aforementioned co-pending U.S. patent application, entitled “Method of block-based motion estimation,” during inversely mapping the MBs of the current frame back to the interpolated frame, at least two MBs in the interpolated frame closest to the interpolated MB are selected as candidates. Among the candidates, the MB that has the MV substantially consistent with the MVs of the macroblocks adjacent to (e.g., left and top of) the interpolated MB is finally selected as the motion vector of interpolated MB.

Although specific embodiments have been illustrated and described, it will be appreciated by those skilled in the art that various modifications may be made without departing from the scope of the present invention, which is intended to be limited solely by the appended claims.

What is claimed is:

1. A method of occlusion handling, comprising:
providing a reference frame and a current frame;
determining at least one foreground object;
determining at least a covered region or an uncovered region with respect to the foreground object; and
interpolating the covered region exclusively accordingly to the current frame, or interpolating the uncovered region exclusively according to the reference frame.

2. The method of claim 1, wherein the reference frame is a previous frame.

3. The method of claim 1, wherein the foreground object is determined according to a corresponding motion vector.

4. The method of claim 3, wherein the motion vector of the foreground object is greater than the motion vector of a background object.

5. The method of claim 1, wherein the covered region is a region that is covered by the foreground object in the reference frame but not covered in the current frame, and the uncovered region is a region that is covered by the foreground object in the current frame but not covered in the reference frame.

6. The method of claim 1, wherein the covered region is a region located toward a direction opposite to a moving direction of the foreground object, and the uncovered region is a region located toward a direction the same as the moving direction of the foreground object.

7. The method of claim 1, wherein the covered region is interpolated by duplicating a corresponding background region in the current frame.

8. The method of claim 1, wherein the uncovered region is interpolated by duplicating a corresponding background region in the reference frame.

9. The method of claim 1, wherein the covered region or the uncovered region is interpolated using a motion vector map.

10. The method of claim 9, before the covered or the uncovered region is interpolated, further comprising a step of correcting a motion vector of the covered or the uncovered region.

11. The method of claim 10, wherein the step of correcting the motion vector of the covered or the uncovered region comprises the following steps:
inversely mapping at least one macroblock (MB) of the current frame back to the interpolated frame;
selecting at least two of the inverse-mapped MBs in the interpolated frame closest to the interpolated MB as candidates; and
selecting, among the candidates, the MB that has a motion vector (MV) substantially consistent with the MVs of the MBs adjacent to the interpolated MB as the MV of interpolated MB.

12. The method of claim 1, wherein the interpolation is pixel-based.

13. The method of claim 1, wherein the interpolation is block-based.
